(19) United States
(12) Patent Application Publication
(10) Pub. No.: US 2011/0213986 A1
(43) Pub. Date: Sep. 1, 2011

(54) Method for Activating Content and Content Reproduction Apparatus

(75) Inventors: Kazuhiro Kanee, Chiba (JP); Muneki Shimada, Tokyo (JP); Takeshi Kono, Tokyo (JP); Takao Tenma, Kanagawa (JP); Shinji Noda, Chiba (JP)

(73) Assignee: Sony Computer Entertainment Inc., Tokyo (JP)

(21) Appl. No.: 13/000,548

(22) PCT Filed: Apr. 20, 2010
(86) PCT No.: PCT/JP10/02849

§ 371 Date: Feb. 3, 2011

(30) Foreign Application Priority Data
Sep. 30, 2009 (JP) 2009226894

(51) Int. Cl. G06F 21/22

(52) U.S. Cl. 713/187

(57) ABSTRACT

A firmware verification section verifies whether a firmware for controlling the activating of contents has been falsified or not, prior to the activating of the contents; a decoding key setting section sets a key to the firmware; the key is used to decode an encrypted activation program for activating the contents, when the firmware has not been falsified; and an activation program decoding section decodes the encrypted activation program by using the firmware with the key set to the firmware.

### TECHNICAL FIELD

The present invention relates to a method for controlling the activation of a content.

### BACKGROUND ART

A reproduction apparatus that enables reproduction of games, music, photos, moving images, etc., browsing of web contents, and the like is normally provided with a firmware. The firmware meant here is a program for supplying a user with an interface for controlling the reproduction apparatus to realize such functions and realizing a function of transferring the control of the reproduction apparatus to a paid content program of a game or the like. A firmware is updated periodically for the purpose of adding new functions or the like and normally made available to the public free of charge. The user can run the new functions on his/her reproduction apparatus by acquiring updated functions through such procedure as downloading a new firmware.

### DISCLOSURE OF INVENTION

### [Problems to be Solved by the Invention]

Anyone can freely obtain a firmware, which is open to the public. Therefore, there are possibilities that the system in the firmware for transferring control to a content program is falsified or tampered with by a third party other than the firmware supplier and thus a content program that should not normally be executed by the reproduction apparatus, such as a content illegally extracted from a recording medium, is executed.

The present invention has been made in view of problems such as described above, and a purpose thereof is to provide a technology for controlling the activating of a program safely by a reproduction apparatus.

### [Means for Solving the Problem]

In order to resolve the above-described problems, one embodiment of the present invention relates to a method for activating a content by a processor. The method comprises: verifying whether a firmware for controlling the activation of the content has been falsified or not, prior to the activation of the content; setting a decoding key to the firmware, the decoding key being used to decode an encrypted activation program for activating the content, when the firmware has not been falsified; and decoding the encrypted activation program by using the firmware with the decoding key set thereto.

In order to resolve the above-described problems, another embodiment of the present invention relates to a content reproduction apparatus. The apparatus comprises: a firmware verification unit configured to verify whether a firmware for controlling the activation of a content has been falsified or not, prior to the activation of the content; a decoding key setting unit configured to set a decoding key to the firmware, the decoding key being used to decode an encrypted activation program for activating the content, when the firmware has not been falsified; and an activation program decoding unit configured to decode the encrypted activation program by using the firmware with the decoding key set thereto.

Optional combinations of the aforementioned constituting elements, and implementations of the invention in the form of methods, systems, computer programs, recording media recording the computer programs, and so forth may also be effective as additional modes of the present invention.

### [Advantageous Effects]

The present invention achieves a technique by which to safely control the activating of a program by a reproduction apparatus.

### BRIEF DESCRIPTION OF DRAWINGS

FIG. 1 is a schematic illustration of function blocks of a firmware loaded in a reproduction apparatus according to a first embodiment and a game program to be executed by the reproduction apparatus, which are involved in a process from the activating to the end of the game program.

FIG. 2 is a flowchart showing a flow of processings done by a firmware and a game program from an execution instruction to a game end of a game program in a first embodiment.

FIG. 3 is a schematic illustration of function blocks of a game program to be executed by a reproduction apparatus according to a second embodiment, which are involved in processes from the activating to the end of the game program.

FIG. 4 is a flowchart showing a flow of processings done by a firmware and a game program from an execution instruction to a game end of a game program in a second embodiment.

FIG. 5 is a schematic illustration of function blocks of a game program to be executed by a firmware, loaded in a reproduction apparatus according to a third embodiment, and the reproduction apparatus, and a decoding key setting program specialized in the setting of a key for decoding an activation program; the function blocks of FIG. 5 involve the processes from the activating to the end of the game program.

FIG. 6A is a flowchart showing a flow of processings done by a firmware and a decoding key setting program from an execution instruction of a game program to a transfer of control to the game program in a third embodiment.

FIG. 6B is a flowchart showing a flow of processings, namely the latter part thereof in FIG. 6A, done by a game program from the receiving of control of a reproduction apparatus from a firmware, to the returning of control thereof to the firmware.

### BEST MODE FOR CARRYING OUT THE INVENTION

The preferred embodiments of the present invention (hereinafter referred to as “embodiments”) will be described by dividing them into three embodiments, namely, first embodiment, second embodiment, and third embodiment. These embodiments will be first outlined before a description thereof. Hereinbelow, an explanation of a content program will be given by taking a game program as an example.

The first embodiment is such that an activation program for activating a game is encrypted in advance and a key to be used in decoding the activation program is embedded in a firmware. The second embodiment is such that a verification to determine whether the firmware of a reproduction apparatus has been falsified or not is performed in a game program executed by the reproduction apparatus; if any falsification is verified, the game program is terminated. The third embodiment is such that a verification to determine whether the firmware of a reproduction apparatus has been falsified or not is performed prior to the activating of a game program; if the absence of any falsification is verified, a key used to decode a previously encrypted activation program for activating the game is put in a usable state. In the third embodiment, the verification to determine any falsification of the firmware and the setting of the key are done by a dedicated program which is different from the programs of the firmware, game, or the like. This program, which is read out before the activating of a game and executed, is not resident in memory.

### First Embodiment

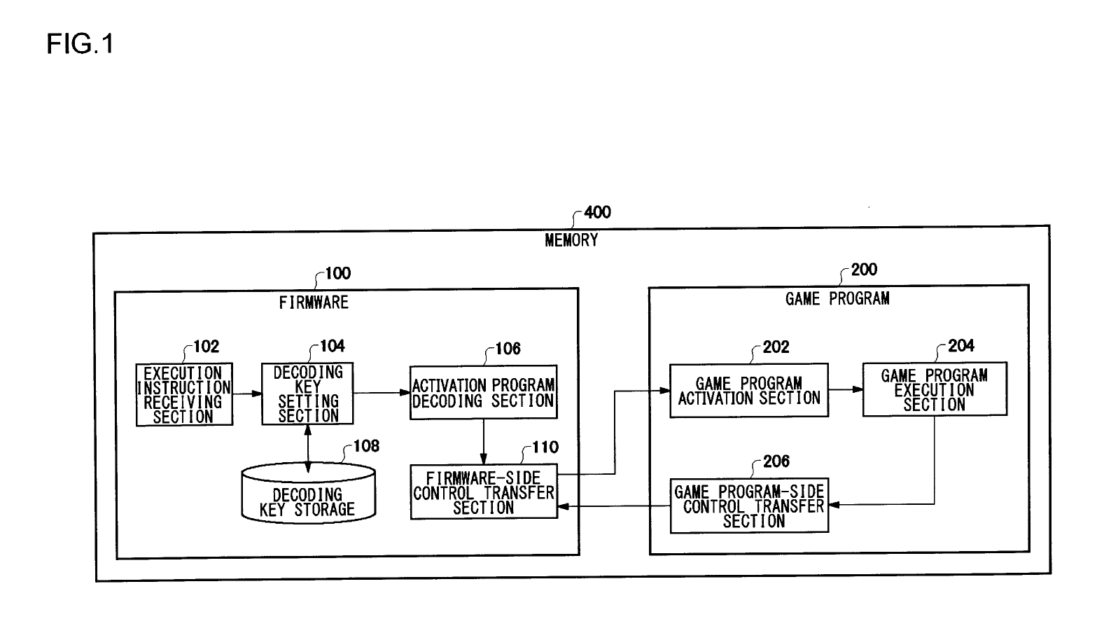

FIG. 1 is a schematic illustration of function blocks of a firmware 100 loaded in a reproduction apparatus according to the first embodiment and a game program 200 to be executed by the reproduction apparatus, which are involved in the process from the activating to the end of the game program 200. The firmware 100 and the game program 200 are loaded into memory 400 of the reproduction apparatus and executed by a not-shown processor of the reproduction apparatus.

The firmware 100 includes an execution instruction receiving section 102, a decoding key setting section 104, an activation program decoding section 106, a decoding key storage 108, and a firmware-side control transfer section 110. The execution instruction receiving section 102 receives an instruction for execution of a game program from the user of the reproduction apparatus. This can be accomplished by the use of a known technology such as GUI (Graphical User Interface). The decoding key setting section 104 first receives information on a game program from the execution instruction receiving section 102. Then the decoding key setting section 104 acquires a key to be used in decoding a program for activating the game from the decoding key storage 108.

It is to be noted here that the activation program for activating the game is encrypted in advance by the creator of the game. The key to be used for encryption and decoding must be a latest key stored in the latest firmware 100 at the creation of the game. If the arrangement is such that a key is added whenever the firmware 100 is updated, then an attempt by a third party at decoding the activation program employing the latest key will fail even when there has been a leak of a past key to the third party through some means. Also, when a leak of a latest key to a third party has been confirmed, the firmware 100 may be again updated to one with a new key added.

Therefore, the “information on a game program” is information by which to identify a key for decoding an activation program of the game, or more specifically information such as the release date and title of the game or the version of the key. Also, the decoding key storage 108 stores all the keys having been created for the decoding of the activation programs of the games released in the past.

It is to be noted here that encryption and decoding of an activation program can be accomplished by the use of a known public key cryptosystem such as the RSA cryptosystem. Alternatively, they may be accomplished by the use of a shared key agreed upon in advance between the creator of the firmware 100 and the creator of the game program 200.

The activation program decoding section 106 receives the key which the decoding key setting section 104 has acquired from the decoding key storage 108 and decodes the activation program. With the activation program decoded, the firmware-side control transfer section 110 transfers the control of the reproduction apparatus to the game program 200.

The game program 200 includes a game program activation section 202, a game program execution section 204, and a game program-side control transfer section 206.

The game program activation section 202 performs an initialization for the execution of a game program at the reproduction apparatus by executing an activation program decoded by the activation program decoding section 106. The game program execution section 204 executes the main part of the game program and controls the reproduction apparatus, thereby presenting the game to the user. Upon termination of the game program at the game program execution section 204, the game program-side control transfer section 206 transfers the control of the reproduction apparatus to the firmware 100 by performing a post-processing such as memory release.

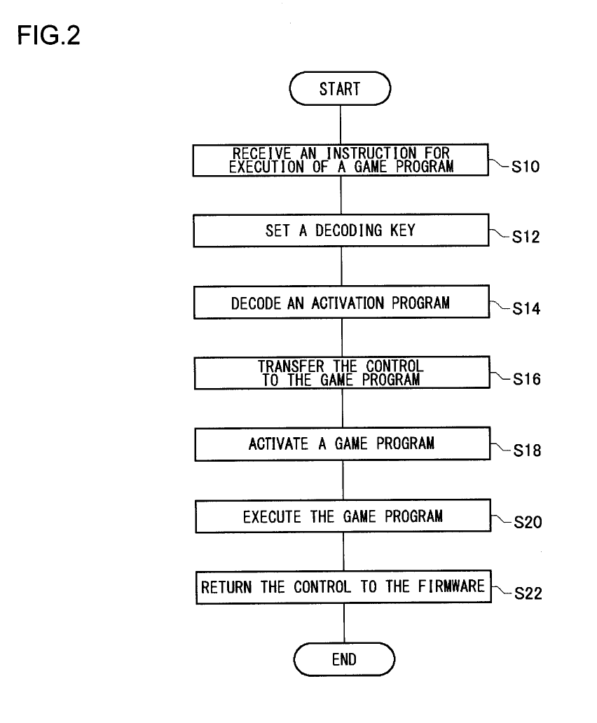

FIG. 2 is a flowchart showing a flow of processings done by the firmware 100 and the game program 200 from the execution instruction to the game end of a game program in the first embodiment. The processings in this flowchart are started at the instruction for execution of a game program by the user.

The execution instruction receiving section 102 receives an instruction for execution of a game program from the user of the reproduction apparatus (S10). The decoding key setting section 104 acquires a key for decoding an activation program from the decoding key storage 108 (S12). The activation program decoding section 106 receives the key which the decoding key setting section 104 has acquired from the decoding key storage 108 and decodes the activation program (S14). With the activation program decoded, the firmware-side control transfer section 110 transfers the control of the reproduction apparatus to the game program 200 (S16).

The game program activation section 202 performs an initialization for the execution of the game program at the reproduction apparatus by executing the activation program (S18). The game program execution section 204 controls the reproduction apparatus, thereby presenting the game to the user (S20). Upon termination of the game program at the game program execution section 204, the game program-side control transfer section 206 transfers the control of the reproduction apparatus to the firmware 100 (S22). With the completion of the transfer of control, the processings of the present flowchart come to an end.

A scene of actual use according to the first embodiment implementing the structure as described above is described below. First, the user inserts a recording medium storing a game program in the reproduction apparatus and instructs the start of the game. The firmware 100 verifies the information on the game program and sets the key for decoding the activation program. With the key set, the activation program is decoded and the user can play the game.

If the firmware 100 determines from the information on the game program that the firmware 100 does not have the key for decoding the activation program, the firmware 100 will issue a message to the user that the firmware 100 must be updated using an updating firmware stored in the recording medium storing the game program or that the firmware 100 must be updated by downloading a latest firmware through a network or the like.

Thus, according to the first embodiment, even when there has been a leak of a key possessed by the firmware 100 to a third party for some reason (for example, a third party obtains the key through analysis of the firmware 100), updating the firmware by adding a new key can prevent the third party from illegally playing the game with an activation program encrypted using the key.

### Second Embodiment

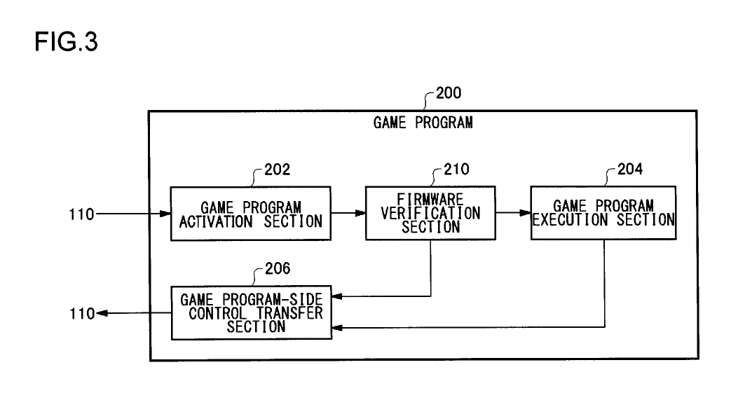

FIG. 3 is a schematic illustration of function blocks of a game program 200 to be executed by the reproduction apparatus according to a second embodiment, which are involved in the processes from the activating to the end of the game program 200. The firmware 100 for the second embodiment is the same as that for the first embodiment, so that the repeated description thereof will be omitted. Similar to the first embodiment, the firmware 100 and the game program 200 are loaded into the memory 400 of the reproduction apparatus and executed by a not-shown processor of the reproduction apparatus.

The game program 200 according to the second embodiment, as with the game program 200 according to the first embodiment, includes a game program activation section 202, a game program execution section 204, and a game program-side control transfer section 206. The game program 200 in the second embodiment further includes a firmware verification section 210.

The game program activation section 202 performs an initialization for the execution of a game program at the reproduction apparatus by executing an activation program decoded by the activation program decoding section 106. With the game on by the execution of the activation program, the firmware verification section 210 performs a verification to determine whether the firmware 100 loaded in the reproduction apparatus has been falsified by a third party or not.

Here the firmware verification section 210 can accomplish the verification with the supplier of the firmware providing an API (Application Program Interface) to the developer of the game. The API verifies whether the firmware has been falsified by a third party or not by a known method such as checking on the memory assignment of the execution program and data of the firmware 100 which have been loaded in the memory 400.

When the firmware verification section 210 has confirmed the validity of the firmware 100 as being one provided by the supplier of the firmware, the game program execution section 204 presents the game to the user by controlling the reproduction apparatus. Upon termination of the game program at the game program execution section 204, the game program-side control transfer section 206 transfers the control of the reproduction apparatus to the firmware 100. If the firmware verification section 210 determines the invalidity of the firmware 100, the firmware verification section 210 conveys it to the game program-side control transfer section 206, which transfers the control of the reproduction apparatus to the firmware 100.

Or it may also be so arranged that when the firmware verification section 210 determines the invalidity of the firmware 100, the game program execution section 204 executes the game program in an invalidity detection mode different from when the validity of the firmware 100 is determined. The “invalidity detection mode” meant here is a mode into which the game program execution section 204 enters when the firmware verification section 210 has determined the invalidity of the firmware 100. In this mode, the game program execution section 204 displays a message indicating the invalidity of the firmware or executes the game program by raising the challenge level of the game higher than normal. The adjustment of the challenge level of the game can be made by adjusting the parameters in the execution of the game, such as quickening the progress speed of the game or making an enemy in the game stronger.

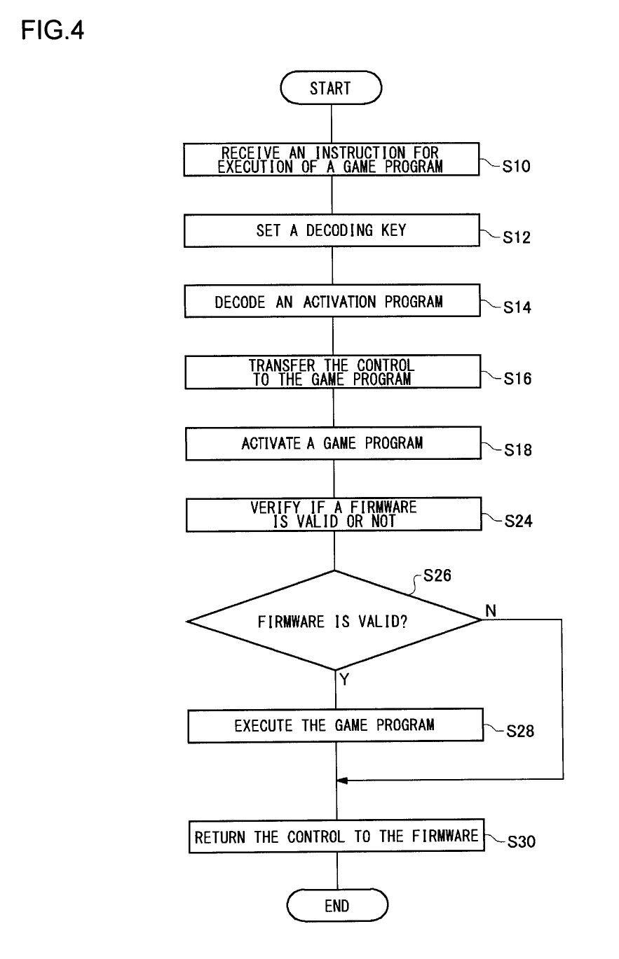

FIG. 4 is a flowchart showing a flow of processings done by the firmware 100 and the game program 200 from the execution instruction to the game end of a game program in the second embodiment. The flow from the receiving of an instruction for execution of a game program from the user of the reproduction apparatus by the execution instruction receiving section 102 (S10) to the initialization for the execution of the game program at the reproduction apparatus by the game program activation section 202 activating the game program (S18) is the same as that of the first embodiment.

With the game on by the execution of the activation program, the firmware verification section 210 performs a verification to determine whether the firmware 100 loaded in the reproduction apparatus has been falsified by a third party or not (S24). If the firmware 100 is valid (S26Y), the game program execution section 204 will present the game to the user by controlling the reproduction apparatus (S28). Upon termination of the game program at the game program execution section 204, the game program-side control transfer section 206 transfers the control of the reproduction apparatus to the firmware 100 (S30). If the firmware 100 is not valid (S26N), the game program will not be executed, with the control of the reproduction apparatus transferred immediately to the firmware 100 (S30). With the control of the reproduction apparatus transferred to the firmware 100, the processings of the present flowchart come to an end. Note that provided the game program execution section 204 has an “invalidity detection mode”, the arrangement may also be such that when the firmware 100 is not valid (S26N), the game program is executed with the game program execution section 204 entering the “invalidity detection mode”.

A scene of actual use according to the second embodiment implementing the structure as described above is described below. Similar to the first embodiment, the user first inserts a recording medium storing a game program in the reproduction apparatus and instructs the start of the game. The firmware 100 verifies the information on the game program and sets the key for decoding the activation program. With the key set, the activation program is decoded and the game program starts running.

With the start of the game program, a verification to determine whether the firmware 100 has been falsified by a third party or not is performed within the game program. If it is determined that the firmware 100 has been falsified by a third party, then the processings of the game program will be terminated without the main part of the game executed. Thus, even when the game program is executed illegally as a result of falsification of the firmware 100 by a third party and a leak of the key for decoding the activation program, the game program can be terminated without the main part thereof being executed.

### Third Embodiment

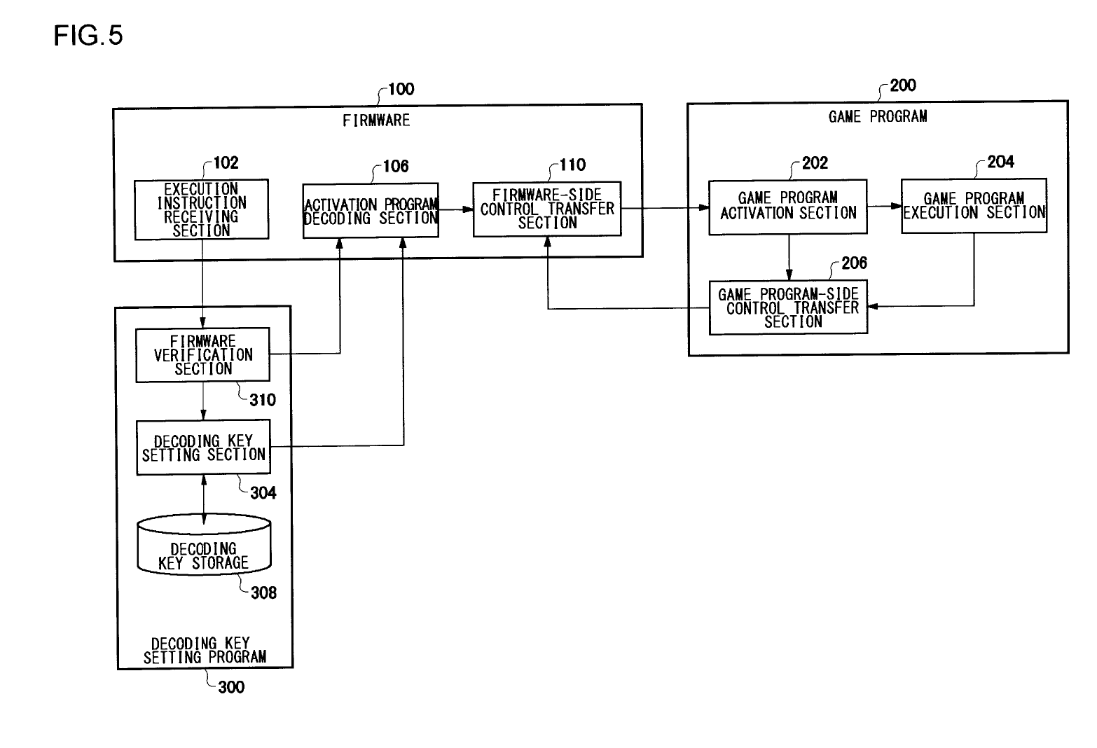

FIG. 5 is a schematic illustration of function blocks of a game program 200 to be executed by a firmware 100, loaded in a reproduction apparatus according to a third embodiment, and the reproduction apparatus and a decoding key setting program 300 specialized in the setting of a key for decoding an activation program. The function blocks of FIG. 5 involve the processes from the activating to the end of the game program 200. The firmware 100, the game program 200 and the decoding key setting program 300 are loaded into the memory 400 of the reproduction apparatus and executed by a not-shown processor of the reproduction apparatus.

The firmware 100 includes an execution instruction receiving section 102, an activation program decoding section 106, and a firmware-side control transfer section 110. When the execution instruction receiving section 102 receives an instruction for execution of a game program from the user of the reproduction apparatus, the decoding key setting program 300 is loaded into the memory 400 and executed.

The decoding key setting program 300 includes a firmware verification section 310, a decoding key setting section 304, and a decoding key storage 308. When the decoding key setting program 300 is started, the firmware verification section 310 first performs a verification to determine whether the firmware 100 loaded in the reproduction apparatus has been falsified by a third party or not. If the absence of any falsification in the firmware 100 is verified, the decoding key setting section 304 will select a key for decoding an activation program from the decoding key storage 308, based on information on a game program received from the execution instruction receiving section 102 via the firmware verification section 310, and will hand over the key to the activation program decoding section 106. When the activation program decoding section 106 receives the key, the execution of the decoding key setting program 300 is terminated and the program 300 is released from the memory 400.

When it is verified that the firmware 100 is falsified, the firmware verification section 310 does nothing and hands over the processing to the activation program decoding section 106, so that the execution of the decoding key setting program 300 is terminated and the program 300 is released from the memory 400.

If the activation program decoding section 106 receives the key from the decoding key setting section 304, it will decode the activation program. If the activation program decoding section 106 does not receive the key from the decoding key setting section 304, it will do nothing. The firmware-side control transfer section 110 transfers the control of the reproduction apparatus to the game program 200.

The game program activation section 202 attempts to start an activation program. Where the activation program is decoded by the activation program decoding section 106, the activation program is properly executed and an initialization for the execution of the game program is performed at the reproduction apparatus. After the initialization, the game program execution section 204 executes the main part of the game and presents the game to the user. Upon termination of the game, the game program execution section 204 transfers the control to the game program-side control transfer section 206.

If the activation program is not decoded by the activation program decoding section 106, the game program activation section 202 cannot start the activation program. In such a case, the game program activation section 202 transfers the control to the game program-side control transfer section 206 without starting the activation program. If the activation program is not decoded, it will be assumed that the firmware 100 has been falsified and therefore a message indicating as such to the user may be displayed and/or a message prompting the user to update the firmware 100 may be displayed.

The game program-side control transfer section 206 transfers the control of the reproduction apparatus to the firmware 100.

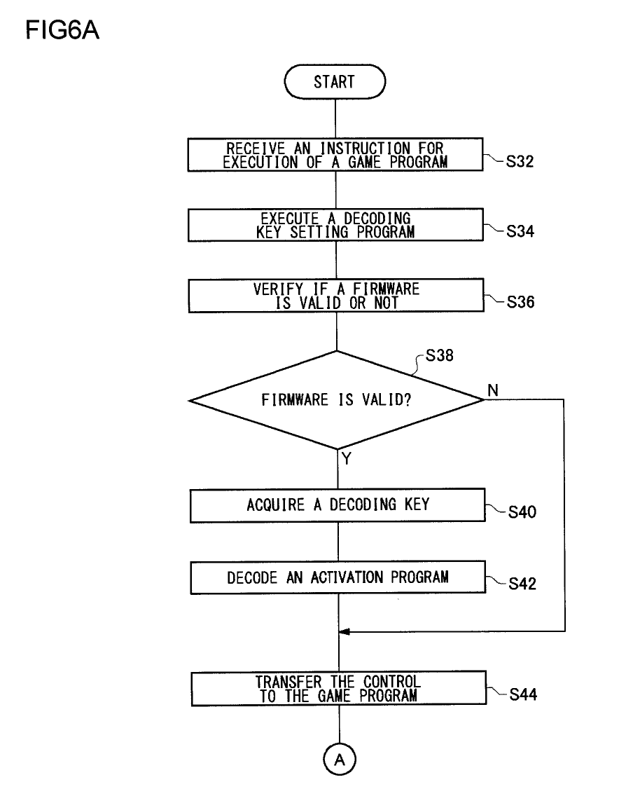

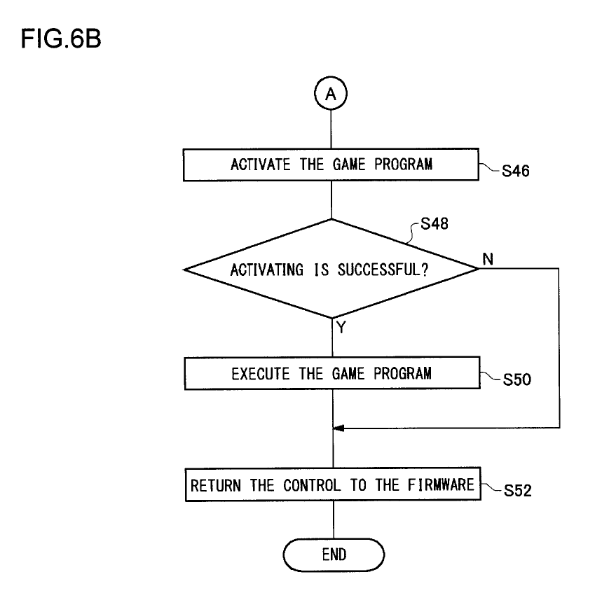

A flow of processings done by the firmware 100, the game program 200 and the decoding key setting program 300 from an execution instruction to the end of a game will be described with reference to FIGS. 6A and 6B.

FIG. 6A is a flowchart showing a flow of processings done by the firmware 100 and the decoding key setting program 300 from an execution instruction of the game program 200 to a transfer of control to the game program 200.

When the execution instruction receiving section 102 receives an instruction for execution of a game program from the user of the reproduction apparatus (S32), the execution instruction receiving section 102 loads the decoding key setting program 300 into the memory 400 and executes the program 300 (S34). The firmware verification section 310 performs a verification to determine whether the firmware 100 has been falsified by a third party or not (S36). If it is verified that the firmware 100 is one in which no falsification has been found, namely the firmware 100 is valid (S38Y), the decoding key setting section 304 will acquire a key used to decode the activation program, from the decoding key storage 308 (S40). Upon receipt of the key from the decoding key setting section 304, the activation program decoding section 106 will decode the activation program (S42).

If it is verified that the firmware 100 has been falsified (S38N), the decoding key setting program 300 will transfer the control to the activation program decoding section 106 of the firmware 100 without acquiring the key. The firmware-side control transfer section 110 transfers the control of the reproduction apparatus to the game program 200, regardless of whether the activation program decoding section 106 has decoded the activation program or not.

FIG. 6B is a flowchart showing a flow of processings done by the game program 200 from the receiving of the control of the reproduction apparatus from the firmware 100, to the returning of the control thereof to the firmware 100.

The game program activation section 202 attempts to start the activation program (S46). If the activation program is decoded by the activation program decoding section 106, the start of the activation program is successful (S48Y) and an initialization for the execution of a game program is performed at the reproduction apparatus. After the initialization, the game program execution section 204 executes the main part of the game and presents the game to the user (S50). Upon termination of the game, the game program-side control transfer section 206 transfers the control of the reproduction apparatus to the firmware 100 (S52).

If the activation program is not decoded by the activation program decoding section 106, the game program activation section 202 cannot start the activation program (S48N). In such a case, the main part of the game is not executed and the game program-side control transfer section 206 transfers the control of the reproduction apparatus to the firmware 100 (S52). When the control of the reproduction apparatus is transferred to the firmware 100, the processing in this flowchart comes to an end.

A scene of actual use according to the third embodiment implementing the structure as described above is described below. Similar to the first embodiment, the user first inserts a recording medium storing a game program in the reproduction apparatus and instructs the start of the game. The firmware 100 verifies the information on the game program and executes the decoding key setting program 300. If the firmware 300 is not falsified, the decoding key setting program 300 will properly set a key for decoding the activation program, so that the user can play the game.

If the firmware 100 determines from the information on the game program that the firmware 100 does not have the key for decoding the activation program, the firmware 100 will replace it by the decoding setting program 300 for use in data update, which is stored in the recording medium storing the game program. Alternatively, the firmware 100 will issue a message to the user that the decoding key setting program 300 must be updated by downloading a latest decoding key setting program through a network or the like.

Thus, according to the third embodiment, even when the firmware 100 is analyzed by a third party, there is no key available to decode the activation program in the firmware 100 and therefore the key will not be leaked to any third party. In a case of the second embodiment, a verification to determine whether the firmware 100 has been falsified by a third party or not is performed within the game program 200. Therefore there are possibilities in the second embodiment that this verification process may be skipped and a game can be illegally played if the third party falsifies the game program. By employing the third embodiment, if it is verified that the firmware 100 is not valid, the game program 200 will not be started at all in the first place. This can prevent the third party from illegally executing the game program 200 by falsifying it.

As described above, the firmware 100 not only serves a function of transferring the control of the reproduction apparatus to the game program 200 by decoding the activation program but also performs a role of reproducing still or moving images on the reproduction apparatus and achieving a function of viewing Web contents and the like. In order to update the firmware 100, all of these functions must be at least verified to operate properly and therefore the frequency of updating the firmware 100 is limited to once in a few months.

According to the third embodiment, the decoding key setting program 300 for performing a verification to determine whether the firmware 100 has been falsified or not and setting the key used to decode the activation program resides separately from the firmware 100. The updating of the decoding key setting program 300 is not bound or affected by the update timing of the firmware 100, so that the frequency of updating the decoding key setting program 300 can be set higher than that of updating the firmware 100. Thus, if a third party attempts to falsify the firmware 100 and the decoding key setting program 300 and illegally execute a game, the decoding key setting program 300 can be updated at an early stage and therefore a new key can be added promptly.

Further, the decoding key setting program 300, which differs from the firmware 100, is a program specialized in the activating of a game. Thus, the decoding key setting program 300 can be distributed to users in such a manner that the decoding key setting program 300 is stored, together with the game program 200, in the recording medium storing the game program 200. This is because the decoding key setting program 300 is not required by a user who does not play the game. In this modification, as compared with a case where the firmware 100 is made available to the public through the Internet or the like, there is less chance for a third party to obtain the decoding key setting program 300. This is advantageous in that the program is less likely to be falsified. Also, the decoding key setting program 300 is called prior to the start of the game program 200 and then it is released from memory when the processing comes to an end. Since the decoding key setting program 300 is not resident in memory, this achieves another advantageous affect in that it is difficult for the third party to analyze the program.

Also, it suffices that the size of the decoding setting program 300 is about one several tenth of that of the firmware 100. This is further advantageous in the following point. That is, this is stress-free on user's part if a new decoding key setting program 300 is automatically downloaded after he/she has connected the reproduction apparatus to the Internet or the like, for instance. This is because the downloading is completed in a short time as compared with a case where the firmware 100 is downloaded.

The present invention has been described based upon illustrative embodiments. The above-described embodiments are intended to be illustrative only and it will be obvious to those skilled in the art that various modifications to the combination of constituting elements and processes could be developed and that such modifications are also within the scope of the present invention.

A description is given so far of a case where the creator of a game encrypts beforehand the activation program. In another modification, the creator of a game can not only encrypt the activation program but also add an electronic signature to the activation program. In such a case, an arrangement is such that the activation program decoding section 106 decodes the activation program and, at the same time, verifies the digital signature. Or a digital signature verification section (not shown) may be provided inside the activation program decoding section 106, so that the digital signature verification section may verify the digital signature. In addition to the encryption of the activation program, the digital signature is given, so that this modification is further advantageous in that the possible falsification of the activation program can be verified.

### EXPLANATION OF REFERENCE NUMERALS

100 Firmware
102 Execution instruction receiving section
104 Decoding key setting section
106 activation program decoding section
108 Decoding key storage
110 Firmware-side control transfer section
200 Game program
202 Game program activation section
204 Game program execution section
206 Game program-side control transfer section
210 Firm ware verification section
300 Decoding key setting program
304 Decoding key setting section
308 Decoding key storage
310 Firmware verification section
400 Memory

### INDUSTRIAL APPLICABILITY

The invention is applicable to the controlling of activating a content.

1. A method for activating content by a processor, the method comprising:
verifying whether firmware for controlling the activation of the content has been falsified or not, prior to the activation of the content;
setting a decoding key to the firmware, the decoding key being used to decode an encrypted activation program for activating the content, when the firmware has not been falsified; and
decoding the encrypted activation program by using the firmware with the decoding key set thereto.

2. The method, for activating content, according to claim 1, wherein a program module for said verifying a firmware and a program module for said setting a decoding key are supplied separately from the firmware, and
wherein the firmware is resident in memory while the program module is loaded into the memory before being executed and released from the memory after being executed.

3. A content reproduction apparatus comprising:
a firmware verification unit configured to verify whether a firmware for controlling the activation of content has been falsified or not, prior to the activation of the content;
a decoding key setting unit configured to set a decoding key to the firmware, the decoding key being used to decode an encrypted activation program for activating the content, when the firmware has not been falsified; and
an activation program decoding unit configured to decode the encrypted activation program by using the firmware with the decoding key set thereto.

4. The content reproduction apparatus according to claim 3, wherein the firmware verification unit and the decoding key setting unit are implemented by a program supplied separately from the firmware, and
wherein the program is updated at a frequency higher than the update frequency of the firmware.

5. The content reproduction apparatus according to claim 3, wherein the program is delivered stored together with the content in a recording medium that stores the content.

6. A non-transitory, computer readable storage medium containing a program, executable by a computer, the program comprising:
a firmware verifying module operative to verify whether a firmware for controlling the activation of content has been falsified or not, prior to the activation of the content;
a decoding key setting module operative to set a decoding key to the firmware, the decoding key being used to decode an encrypted activation program for activating the content, when the firmware has not been falsified; and
an activation program decoding module operative to decode the encrypted activation program by using the firmware with the decoding key set thereto.

7. A non-transitory, computer readable storage medium encoded with a program, to be executed by a processor of a content reproduction apparatus, the program comprising:
a firmware verifying module operative to verify whether a firmware for controlling an operation of the content reproduction apparatus that executes content has been falsified or not, prior to the activation of the content; and
a decoding key acquiring module operative to acquire a key for decoding an activation program from a decoding-key database that stores a plurality of keys, the activation program being for activating the content, the activation program being encrypted beforehand by a creator of the content, when it is verified that the firmware is not falsified by a third party,
wherein said program is provided separately from the firmware.

8. The non-transitory, computer-readable storage medium encoded with a program, according to claim 7, executable by a computer.
